(19) United States
(12) Patent Application Publication
(10) Pub. No.: US 2026/0111199 A1
(43) Pub. Date: Apr. 23, 2026

(54) FORM PAGE CODE GENERATION

(71) Applicant: Shanghai Gewu Zhiyuan Network Technology Co., Ltd., Shanghai (CN)

(72) Inventors: Hongqiang Chen, Beijing (CN); Kexu Yang, Beijing (CN); Yifan Zhang, Beijing (CN); Tianqi Han, Beijing (CN); Qiong Wu, Beijing (CN)

(21) Appl. No.: 18/979,338

(22) Filed: Dec. 12, 2024

(30) Foreign Application Priority Data
Oct. 18, 2024 (CN) 202411466100.3

(51) Int. Cl. G06F 8/41; G06F 8/30

(52) U.S. Cl. CPC G06F 8/447; G06F 8/30

(57) ABSTRACT

Embodiments of the disclosure provide a method, apparatus, storage medium and electronic device for form page code generation. The method includes: obtaining a pre-configuration file corresponding to a target form page, and parsing the pre-configuration file to obtain field information in the target form page; obtaining predetermined first template source code, the first template source code comprising a non-editable portion and an editable portion, and the editable portion comprising an operator and a field to be defined and corresponding to the operator; writing the field information of the pre-configuration file into the field to be defined of the first template source code; and generating editing code information based on the operator and the field information of the pre-configuration file, code information of the non-editable portion and the editing code information generating first code information corresponding to the target form page.

### CROSS-REFERENCE

This application claims priority to Chinese Patent Application No. 202411466100.3, filed on Oct. 18, 2024 and entitled ‘METHOD, APPARATUS, STORAGE MEDIUM AND ELECTRONIC DEVICE FOR FORM PAGE CODE GENERATION’, which is incorporated herein by reference in its entirety.

### FIELD The embodiment of the present disclosure relates to the technical field of computer technology, in particular relates to form page code generation.

### BACKGROUND

A business system includes a very large number of list pages and form pages of a configuration class, at present, these pages are manually developed by the front-end developer. This development model has the following problems: first, the development is time-consuming; second, different developers have different coding styles, which is not conducive to the maintenance of the later; third, the manual development of the code has a high rate of bugs.

### SUMMARY

The present disclosure provides a method, apparatus, storage medium and electronic device for form page code generation, to implement automatic generation of form page code, improving code style uniformity, and enhancing code development efficiency and development quality.

According to a first aspect, an embodiment of the present disclosure provides a method of generating form page code, including:
obtaining a pre-configuration file corresponding to a target form page, and parsing the pre-configuration file to obtain field information in the target form page;
obtaining predetermined first template source code, the first template source code including a non-editable portion and an editable portion, and the editable portion including an operator and a field to be defined and corresponding to the operator;
writing the field information of the pre-configuration file into the field to be defined of the first template source code; and
generating editing code information based on the operator and the field information of the pre-configuration file, code information of the non-editable portion and the editing code information generating first code information corresponding to the target form page.

According to a second aspect, an embodiment of the present disclosure further provides an apparatus for generating form page code, including:
an information obtaining module, configured to obtain a pre-configuration file corresponding to a target form page, and parse the pre-configuration file to obtain field information in the target form page; and
a template obtaining module, configured to obtain predetermined first template source code, the first template source code including a non-editable portion and an editable portion, and the editable portion including an operator and a field to be defined and corresponding to the operator;
an information writing module, configured to write the field information of the pre-configuration file into the field to be defined of the first template source code; and
a code generating module, configured to generate an editing code information based on the operator and the field information of the pre-configuration file, code information of the non-editable portion and the editing code information generating first code information corresponding to the target form page.

According to a third aspect, an embodiment of the present disclosure further provides an electronic device, including:
one or more processors; and
a storage apparatus, configured to store one or more programs,
the one or more programs, when executed by the one or more processors, causing the one or more processors to implement the method of generating form page code provided in the embodiments of the present disclosure.

According to a fourth aspect, an embodiment of the present disclosure further provides a storage medium including computer-executable instructions, wherein the computer-executable instructions, when executed by a computer processor, are configured to perform the method of generating form page code provided in the embodiments of the present disclosure.

According to the embodiments of the present disclosure, a template source code is set, code information of a target form page is generated through the template source code, and the code information of the form page generated through the template source code has the same development style, to maintain the code information of different form pages conveniently. Meanwhile, the template source code includes a non-editable portion and an editable portion, the editable portion may be updated through the pre-configuration file corresponding to the target form page, without editing the non-editable portion, improving the standardization of the code information of the target form page, and avoiding bugs caused by manual writing, reducing the bug rate. Furthermore, operator is set in the editable portion of the template source code, and by performing corresponding operation on the field information by the operator in the pre-configuration file, the editing code information is obtained, thereby implementing automatic generation of the structured information.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It would be appreciated that the drawings are schematic, and elements and elements are not necessarily drawn to scale.

FIG. 1 is a schematic flowchart of a method of generating form page code according to an embodiment of the present disclosure;

FIG. 2 is a schematic diagram of a process of generating first code information according to an embodiment of the present disclosure;

FIG. 3 is a schematic flowchart of a method of generating form page code according to an embodiment of the present disclosure;

FIG. 4 is a schematic diagram of a process of generating linkage code information according to an embodiment of the present disclosure;

FIG. 5 is a schematic structural diagram of an apparatus for generating form page code according to an embodiment of the present disclosure;

FIG. 6 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and would not be construed as limited to the embodiments set forth herein. Instead, these embodiments are provided for a more thorough and complete understanding of the present disclosure. It would be appreciated that the drawings and embodiments of the present disclosure are for exemplary purposes only and are not intended to limit the scope of the present disclosure.

It would be appreciated that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term ‘including’ and variations thereof are open-ended, i.e., ‘including but not limited to’. The term ‘based on’ is ‘based at least in part on’. The term ‘one embodiment’ means ‘at least one embodiment’; the term ‘a further embodiment’ means ‘at least one further embodiment’; the term ‘some embodiments’means ‘at least some embodiments’. The relevant definitions of other terms will be given below.

It would be noted that the concepts such as ‘first’ and ‘second’ mentioned in this disclosure are merely used to distinguish different apparatuses, modules, or units, and are not intended to limit the order or interdependence of the functions performed by these apparatus, modules or units.

It would be noted that the modification of ‘a’ and ‘a plurality’ mentioned in this disclosure is illustrative and not limiting, and would be understood by those skilled in the art to mean ‘one or more’ unless the context clearly indicates otherwise.

The names of messages or information exchanged between a plurality of apparatuses in the embodiments of the present disclosure are for illustrative purposes only and are not intended to limit the scope of such messages or information.

It would be appreciated that, before the technical solutions disclosed in the embodiments of the present disclosure are used, the types of personal information related to the present disclosure, the usage scope, the usage scenario and the like would be notified to the user in an appropriate manner according to the relevant laws and regulations and obtain the authorization of the user.

For example, in response to receiving an active request from a user, sending prompt information to the user to explicitly prompt the user that the requested operation will require obtaining and using the personal information of the user. Therefore, the user may autonomously select, based on the prompt information, whether to provide personal information to software or hardware such as electronic device, application, server, or storage medium that performing the operation of the technical solution of the present disclosure.

As an optional but non-limiting implementation, in response to receiving the active request of the user, the manner of sending the prompt information to the user may be, for example, in the form of a pop-up window, in which the prompt information is presented in the form of text. In addition, the pop-up window may contain an option control for the user to select ‘agree’ or ‘disagree’ to provide the personal information to the electronic device.

It may be appreciated that the foregoing notification and obtaining a user authorization process is merely illustrative and does not constitute a limitation on implementations of the present disclosure, and further manners of meeting related laws and regulations may also be applied to implementations of the present disclosure.

It may be appreciated that the data involved in the technical solution (including but not limited to the data itself, the obtain or use of the data) would follow the requirements of the corresponding laws and regulations and related regulations.

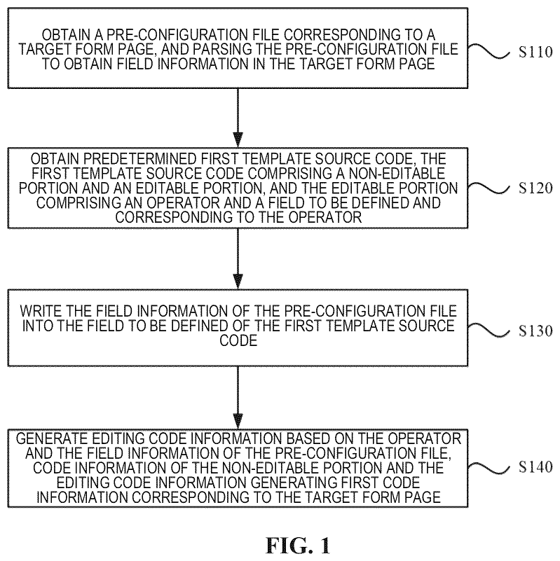

FIG. 1 is a schematic flowchart of a method of generating form page code according to an embodiment of the present disclosure. The embodiments of the present disclosure are applicable in the case of automatic generating of form page code, the method may be performed by an apparatus for generating form page code, which may be implemented in the form of software and/or hardware, optionally by an electronic device, which may be, for example, a mobile terminal, a PC, or a server. Wherein the mobile terminal may be, for example, a cell phone or a tablet.

As shown in FIG. 1, the method includes:
S110: obtain a pre-configuration file corresponding to a target form page, and parsing the pre-configuration file to obtain field information in the target form page.
S120: obtain predetermined first template source code, the first template source code including a non-editable portion and an editable portion, and the editable portion including an operator and a field to be defined and corresponding to the operator.
S130: write the field information of the pre-configuration file into the field to be defined of the first template source code.
S140: generate editing code information based on the operator and the field information of the pre-configuration file, code information of the non-editable portion and the editing code information generating first code information corresponding to the target form page.

In this embodiment, in the same system or the same application may include a plurality of form pages, in order to improve the uniformity of the code style of a plurality of form pages in the same system or the same application as well as the accuracy and standardization of the code, a template source code is pre-set. The template source code may be determined based on the historical code of a generated form page, and the template source code may be the source code that provides a template for the subsequent process of generating the code information for the form page. The template source code includes a non-editable portion and an editable portion, the non-editable portion being a portion of the source code that is not capable of being edited again, and the editable portion being a portion of the source code that is capable of being edited again. The editable portion of the template source code may be edited to generate new form page code information.

It may be appreciated that the partial source code of the non-editable portion is the same as the part of the code information in the historical code of the generated form page, and the partial source code of the non-editable portion may include, but is not limited to, frame code information of the form page and invocation code information for a database, etc., which may represent the code style. Accordingly, the partial source code of the non-editable portion of the first template source code is in a non-editable state during the generation process of the code information of the target form page, so that the code information of the target form page has the same style as the historical code information of the generated form page. Moreover, the partial source code of the non-editable portion improves the standardization of the code information of the target form page and avoids bugs that may occur during the coding process of the code of the portion herein by the developer.

It may be appreciated that fields included in different form pages may be different, for example, fields A, B, and C that may be included in form page 1, fields F and E that may be included in form page 2, the portion of the form page code that represents the above fields correspondingly is changeable, and different form pages may be formed by setting different fields. Accordingly, in the process of creating the template source code, a portion of the code of the historical code of the generated form page that is changeable may be set as an editable portion and a portion of the code of the historical code of the generated form page that is not changeable may be set as a non-editable portion to form a template source code. Optionally, the association code information of the field in the generated form page is recognized in the historical code of the generated form page, the association code information of the field in the historical code of the generated form page is determined to be a changeable portion of the code, and is set as an editable portion. The code information other than the association code information of the fields in the historical code of the generated form page code is determined to be a non-changeable portion of the code, the non-changeable portion of the code is retained, and the non-editable portion is set to form a code template. Optionally, the historical code of the generated form page is obtained, the historical code of the generated form page includes a first mark and a second mark, the first mark represents a non-changeable code, and the second mark represents a changeable code. By recognizing the marks corresponding to each code information in the historical code respectively, the code information setting the first mark is retained and set as a non-editable portion; the code information setting the second mark is set as an editable portion to form the template source code.

The template source code may be pre-created, e.g., the template source code may be a plurality of template source codes, and the first template source code may be the template source code required for generating the template form page, and may be one of the plurality of template source codes. Optionally, the first template source code may be determined in response to a template selection operation. By way of example, an interaction page is displayed, the interaction page includes a plurality of template source codes to be selected, and the first template source code may be determined based on a template selection operation by a user on the interaction page. Optionally, the first template source code may be determined based on a type of the target form page, different types may correspond to different template source codes, and a corresponding template source code may be invoked as the first template source code based on the type of the target form page.

In this embodiment, a target form page is a form page to be generated according to the user's requirement. Requirement information corresponding to the target form page and the first template source code generate code information corresponding to the target form page, to implement development of the target form page. Among them, the requirement information corresponding to the target form page may be reflected by a pre-configuration file corresponding to the target form page. Among them, the pre-configuration file corresponding to the target form page may include IDL (Interface Definition Language) information.

In some embodiment, the pre-configuration file corresponding to the target form page may be pre-set or imported from external. By parsing the pre-configuration file, pre-configuration information is obtained, which includes field information of a field included in the target form page. Specifically, the pre-configuration file may be parsed in a syntax tree to obtain the field information, wherein the field information may include but is not limited to a field name, a field type and a field enumeration value. In some embodiments, the pre-configuration information further includes information such as whether there has a verification rule or a linkage relationship and the like.

Optionally, after obtaining the field information, the method may further include: displaying the field information of the target form page on an interaction page; and in response to an editing operation on the field information on the interaction page, updating the field information. By displaying the field information on the interaction page, the developer may view the field information through the interaction page. Further, when the parsed field information does not meet the requirement of the target form page, the editing operation may be performed on the field information by using the interaction page to update the field information. The editing operation to the field information on the interaction page may include, but is not limited to, add information, modify information, and delete information. Correspondingly, the update field information includes, but is not limited to, add a new field and information corresponding to the new field, delete one or more fields and information corresponding to the fields, and modify information corresponding to any one of fields, for example, add, delete, or modify an enumeration value of a field, such as, modify a verification rule or a linkage relationship.

By visually displaying the parsed field information, the field information of the target form page is conveniently edited and confirmed, the field information in the target form page may implement dynamic change, without repeated modifications to the pre-configuration file. Correspondingly, code information corresponding to the target form page code is generated based on the updated field information.

In some embodiments, the pre-configuration file corresponding to the target form page may be generated based on field information of the target form page collected by the interaction page. Specifically, an interaction page is displayed, and the interaction page includes a field information collection control that obtains field information input by the user via the field information collection control. The interaction page may also include a field creation control that, in response to a trigger operation on the field creation control, displays in the interaction page an added field information collection control for collecting field information of the added field. The pre-configuration file is formed by collecting the at least one field and the corresponding field information input by the user through the interaction page, which implements a visual configuration process of the pre-configuration file and simplifies the generation process of the pre-configuration file.

In the above embodiment, a storage address for the code information of the target form page may also be selected in the interaction page, for example, the storage address may be a certain folder to facilitate the storage of the code information of the target form page.

Corresponding first code information for the target form page code is generated from the parsed field information and the first template source code. Specifically, the field information and the first template source code may be input into a logic generator, and the first code information is output through the logic generator. The logic generator generates the code quickly and consumes few computational resources, satisfying the need for rapid generation of a large amount of structured code information.

The editable portion of the first template source code includes an operator and a field to be defined corresponding to the operator, wherein the operator may be understood as a symbol representing a type of operation. Each operator may represent a type of operation. The field to be defined corresponding to the operator may be a template field with a placeholder effect. Therein, it may be the case that the code operation logic in the historical code is abstracted into corresponding operators based on the type of code operation, and the operators are introduced in the first template source code. Accordingly, the logic generator may, by recognizing the operator, may correspondingly execute the code operation logic corresponding to the operator to obtain the code information corresponding to the said operator. It would be appreciated that the code information corresponding to the field in the target form page code is obtained by executing the corresponding code operation logic on the parsed field information by the operator.

By injecting the parsed field information into the first template source code, a field to be defined corresponding to the operator is replaced by the parsed field information. By way of example, the parsed fields include aaa, bbb, and ccc, and the field information of each of the above fields, and accordingly, the above fields and the field information are written to the corresponding fields to be defined in the first template source code, so as to implement the combination of the operator and the parsed field information. By way of illustration, the defined field “NAME” in the first template source code is replaced with the field name of the field in the parsed field information, and the defined field “TITLE” in the first template source code is replaced with the field type lable, etc. of the field in the parsed field information. The corresponding field to be defined in the first template source code and the parsed field information have a corresponding relationship, and based on the above corresponding relationship, the field information is injected into the field to be defined in the first template source code. Code information corresponding to the fields in the target form page is obtained by means of the operator and the parsed out field information, the code information corresponding to the fields in the target form page may form edit code information, and the edit code information and the partial source code of the non-editable portion of the first template source code may form the first code information.

Code information corresponding to the fields in the target form page is obtained by operators and parsing out the field information, the code information corresponding to the fields in the target form page may form edit code information, and the edit code information and the partial source code of the non-editable portion of the first template source code may form the first code information.

Optionally, the operator includes, but is not limited to, one or more of a loop traversal operator, a replacement operator, an insertion operator, and an import operator, wherein, the loop traversal operator may be represented by ForEach for traversing each field in the pre-configuration file, generating component code information corresponding to each field. It is appreciated that the target form page may include a plurality of fields, such as time, product type, logistics manner, and other fields, for each of which corresponding code information is generated separately. Field attributes such as field name/field type of the above fields are injected at the field to be defined corresponding to the loop traversal operator. In the case where the logic generator recognizes the loop traversal operator, the plurality of fields corresponding to the loop traversal operator are traversed, and the code information corresponding to each field is generated separately. Optionally, the logic generator generates the corresponding code information based on field attributes, wherein the field attributes may include a field type, a field name, or an enumerated value. Specifically, the logic generator determines the component type corresponding to the field based on the field attribute, and generates the component code information corresponding to the component type. A corresponding relationship between the component type and the field attribute may be configured in the logic generator, and the component type corresponding to the field attribute may be determined by the above corresponding relationship. By way of example, if the field type is time, or if the field name is xxx_time, the logic generator generates the component code information corresponding to DatePicker component. In an example, the field information corresponding to the field includes enumerated values, the logic generator generates the component code information corresponding to Select component. For example, the field type is name, the logic generator generates the component code information corresponding to the input component.

A replacement operator may be represented by Replace, for replacing the source code information in the first template source code with new code information. Specifically, the new code information may replace characters or strings in the first template source code. Herein, the new code information may be the component code information corresponding to any of the field above or externally imported code information. There is no limitation here. Optionally, a replacement condition is pre-set. When the new code information meets the replacement condition above, the replacement operation is performed. When the replacement condition above is not met, the replacement operation is not performed. Herein, the replacement condition may include a corresponding relationship between the source code information in the first template source code and field of the new code information.

An insertion operator may be represented by Insert, for inserting new code information into the first template source code; wherein the pre-configuration information parsed from the pre-configuration file further includes code insertion position and description information or identification of the insertion code. For example, the code information imported from the external may be read by inserting an identification of the insertion code as new code information, which carries the identification. For example, new code information is generated based on description information of the insertion code, for example, new code information is generated based on the description information of the insertion code by pre-training a neural network model, and the new code information includes, but is not limited to, verification code information corresponding to the field and linkage code information between the fields, and the like.

For example, the code insertion position may be at the top of a certain component of the target form page, and description information of the insertion code is an interface required by the target form page. Interface code information is read, or the interface code information is generated, based on the description information, as new code information, a code insertion operation is performed, and new code information is inserted into the first template source code based on the insertion position. Optionally, the insertion condition is pre-set, the code insertion operation is performed when the new code information meets the insertion condition. When the new code information does not meet the insertion condition, the code insertion operation is not performed. The insertion condition may be configured based on requirement, for example, may be a Boolean condition.

An import operator may be represented by AddImport for importing defined field information of the pre-configuration file, for example, the defined field information may be an enumerated value corresponding to a field.

In this embodiment, generating the editing code information based on the operator and the field information of the pre-configuration file includes: recognizing the operator, and performing an operation corresponding to the operator on field information corresponding to the operator. Specifically, by recognizing the loop traversal operator, the field corresponding to the loop traversal operator is traversed to generate component code information corresponding to each of fields; the source code information in the first template source code is replaced with the component code information corresponding to each of the fields by recognizing the replacement operator; new code information is obtained by recognizing the insertion operator, and the new code information is inserted into the first template source code based on the code insertion position, the new code information may include but is not limited to the verification code information corresponding to the fields and the linkage code information between the fields; the enumerated value corresponding to the field is imported into the first template source code by recognizing the import operator. Editing code information is obtained based on the operation corresponding to the at least one operator, the editing code information may include code information generated by the operation corresponding to the at least one operators. The first template source code is updated by the editing code information to obtain the first code information, i.e., the code information of the non-editable portion and the editing code information form the first code information.

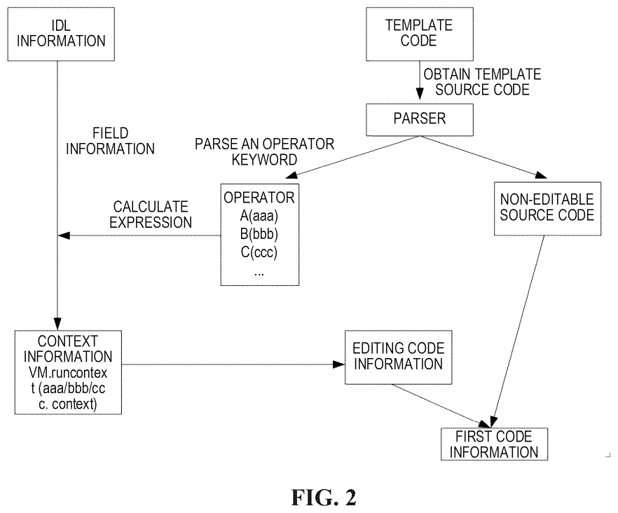

Based on the above embodiments, refer to FIG. 2. FIG. 2 is a schematic diagram of a process of generating first code information provided by the present disclosure embodiments. IDL information (i.e., a pre-configuration file) is obtained, and the IDL information is parsed to obtain field information. The first template source code is obtained, and the first template source code is parsed through a parser to obtain code information of the non-editable portion and an operator of editable portion. By injecting the field information into the field to be defined corresponding to the operator, context information is obtained. The context information is processed through a logic encoder, which sequentially performs the operation corresponding to the operator on the code information to generate editing code information. The editing code information and the code information of the non-editable portion are combined to form the first code information.

According to the technical solution provided by the embodiment, a template source code is set, code information of a target form page is generated through the template source code, and the code information of the form page generated through the template source code has the same development style, to maintain the code information of different form pages conveniently. Meanwhile, the template source code includes a non-editable portion and an editable portion, the editable portion may be updated through the pre-configuration file corresponding to the target form page, without editing the non-editable portion, improving the standardization of the code information of the target form page, and avoiding bugs caused by manual writing, reducing the bug rate. Furthermore, operator is set in the editable portion of the template source code, and by performing corresponding operation on the field information by the operator in the pre-configuration file, the editing code information is obtained, thereby implementing automatic generation of the structured information.

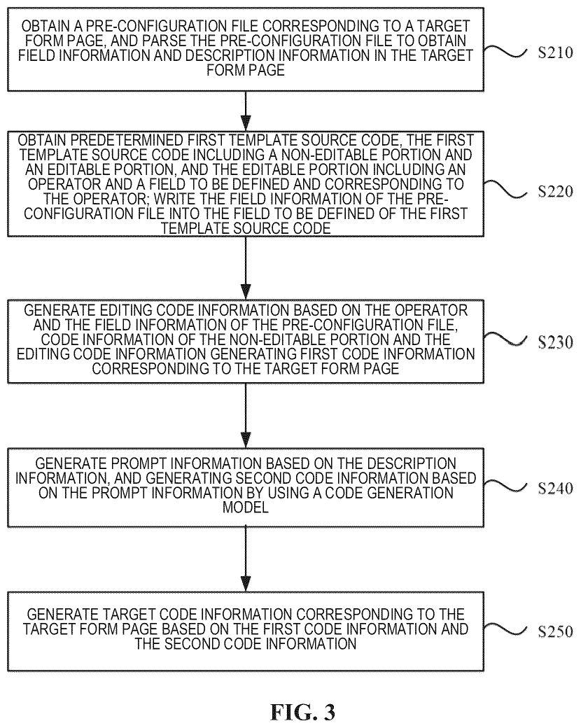

FIG. 3 is a flowchart of a method for generating form page code according to an embodiment of the present disclosure. An optimization is carried out on the basis of the above embodiment. The method specifically includes:
S210: obtain a pre-configuration file corresponding to a target form page, and parse the pre-configuration file to obtain field information and description information in the target form page.
S220: obtain predetermined first template source code, the first template source code including a non-editable portion and an editable portion, and the editable portion including an operator and a field to be defined and corresponding to the operator; write the field information of the pre-configuration file into the field to be defined of the first template source code.
S230: generate editing code information based on the operator and the field information of the pre-configuration file, code information of the non-editable portion and the editing code information generating first code information corresponding to the target form page.
S240: Generate prompt information based on the description information, and generating second code information based on the prompt information by using a code generation model.
S250: Generate target code information corresponding to the target form page based on the first code information and the second code information.

The code information of the target form page includes not only the structured code information corresponding to the at least one field, but also verification code information and/or linkage code information, wherein the verification code information may be understood as code information for implementing a verification rule, for verifying the input information corresponding to the field in the target form page to determine whether the input information corresponding to the field meets a format condition; the linkage code information may be understood as code information that represents a linkage relationship between at least two fields in the target form page, for implementing dynamic linkage between at least two fields in the target form page.

It may be appreciated that the logic of the verification rule and the linkage relationship is very flexible and diverse, a complex verification rule and linkage relationship cannot be described through the structured information, therefore verification code information and linkage code information cannot be generated by the logic generator. For the foregoing problem, a code generation model is pre-set, description information corresponding to the verification rule and/or the linkage relationship is written into the pre-configuration file, and verification code information and/or linkage code information are generated by using the code generation model and the description information.

Optionally, the description information includes verification description information and/or field linkage description information, and the second code information includes verification code information and/or linkage code information. The description information may be collected through an interaction page. The description information may be one or more pieces, may generate the second code information based on each piece of description information, and correspondingly, the second code information may be one or more items.

Therein, the verification description information may be description information of a verification rule of the field in the target form page, for example, the field in the target form page may be time. The verification rule of the time may include integers less than or equal to 24 for the hour data and less than 59 for the minute time and second data, respectively. The linkage description information may be description information of a linkage relationship between two or more fields in the target form page. For example, the field in the target form page may include logistics information and an object type, when the object type is A, the logistics information is B.

The code generation model is a pre-trained neural network model. Optionally, the code generation model may be a Large Language Model (LLM), but there are no restrictions on the type of LLM model. The code generation model may be trained based on the developed sample code information and the description information of the sample code information. This sample code information may be validation code information and/or linkage code information.

Prompt information is generated based on description information parsed from the pre-configuration file, the prompt information is determined as an input of the code generation model to obtain second code information output by the code generation model. When there are a plurality of pieces of description information, prompt information corresponding to each piece of description information is generated separately, and each piece of prompt information is separately processed by using a code generation model to obtain second code information corresponding to each piece of description information. For example, the description information may be determined as prompt information, or the description information may be converted into an embedding vector, and the embedding vector may be determined as prompt information.

It may be appreciated that the first code information may be body code information of the target form page, and the second code information may be additional code information. In some embodiments, the target code information corresponding to the target form page includes the first code information. In some embodiments, the target code information corresponding to the target form page includes the first code information and the second code information; correspondingly, the first code information and the at least one second code information are combined to obtain the target code information.

Optionally, the pre-configuration file includes an insertion position of the second code information, an insertion operation performed on the second code information is implemented through the insertion operator, and the second code information is inserted into the first code information based on the insertion position to form the target code information.

According to the technical solution provided by the embodiments, the first code information is generated based on the pre-configuration file and the first template source code through the logic generator, the second code information is generated through the code generation model and the description information, and the target code information corresponding to the target form page is formed through the first code information and the second code information. The logic generator has high processing efficiency, low consumption resources and supports generation of structured code information corresponding to a large number of fields. The code generation model may support the generation of complex logic code information, and generate the first code information and the second code information through two code generation manners. It considers the generation of structured code information and complex logic code information, and improves the efficiency and reliability of automatic generation of code information.

Based on the foregoing embodiment, to ensure that the second code information is consistent with style of code information in other form pages in the same system or application, second template source code is added to the prompt information to provide template reference for generation of the second code information, so that the second code information and the second template source code have a same style.

Optionally, the second template source code corresponding to the description information is obtained, prompt information is generated based on the second template source code and the description information; the second code information is generated based on the prompt information by using a code generation model. For example, the second template source code is determined based on a code type corresponding to the description information, by way of example, the code type corresponding to the description information may be the linkage code type or the verification code type, and the second template source code may be determined in the pre-set template source code based on the code type corresponding to the description information. For example, the second template source code may be determined based on a template selection operation on the interaction page. The second template source code may be historical verification code information or historical linkage code information.

Optionally, a prompt information assembly template is obtained, the prompt information assembly template may include a prompt of the template source code and a prompt of the description information. For example, the prompt of the template source code may be ‘linkage example code is as follows’, and the prompt of the prompt of the description information may be ‘linkage relationship description information is as follows’. Correspondingly, the second template source code and the description information are respectively added to the corresponding positions of the prompts to form prompt information. The second code information output by a code generation model is obtained by inputting the prompt information into the code generation model.

Based on the foregoing embodiment, it may be appreciated that the description information is input for the user. In order to avoid the interference of the description habits or differences of the description information input by different users in the generation process of the second code information, in this embodiment, a predetermined knowledge library is se, which includes the knowledge documents in the same system or application. By matching the knowledge information corresponding to the description information in the predetermined knowledge base, the context information may be provided for the description information, which is convenient for the code generation model to understand the description information.

Optionally, the description information is converted into vector information; similarity matching is performed, for the vector information, in a predetermined knowledge library to obtain knowledge information matching the description information, the predetermined knowledge library including vector information corresponding to a predetermined knowledge document; the prompt information is updated based on the knowledge information matching the description information; and the second code information is generated based on the prompt information by using the code generation model.

In this embodiment, the vector information corresponding to the description information may be obtained by performing vectorization processing on the description information. For example, the vector information may be obtained by processing the description information through a vectorization model. Alternatively, it may obtain a plurality of keywords by text segmentation of description information, perform vectorization processing on the keywords respectively, and the vector information corresponding to plurality of keywords is composed of the vector information corresponding to the description information.

The predetermined knowledge library is pre-created, including a database of vector information corresponding to the predetermined knowledge document. The predetermined knowledge library may be constructed by: obtaining a predetermined knowledge document, the predetermined knowledge document may be a webpage document or a text document and may be a related document of a system or an application. Performing a segmentation processing on the predetermined knowledge document to obtain a plurality of document blocks, performing a vectorization processing on each document library to obtain vector information corresponding to the document blocks respectively, and constructing a predetermined knowledge library based on the vector information corresponding to the document blocks respectively. Therein, the predetermined knowledge library may include a corresponding relationship between index information of the document library and vector information corresponding to the document block. The predetermined knowledge library may be updated regularly, for example, adding vector information corresponding to the new knowledge document, and improving comprehensiveness and accuracy of the predetermined knowledge base.

The similarity of the vector information corresponding to the description information is matched in the predetermined knowledge library. Specifically, the similarity data of the vector information corresponding to the description information and each vector information in the predetermined knowledge library are determined respectively, and the knowledge information matching the description information is filtered through the similarity data. For example, the document block corresponding to the vector information whose similarity data is greater than the predetermined threshold may be determined as the knowledge information matching the description information. Alternatively, document blocks corresponding to vector data are sorted based on similarity data, and K document blocks are filtered as knowledge information that matches the description information.

Optionally, the prompt information is generated based on the description information and the knowledge information matched by the description information. Optionally, prompt information is generated based on the description information, the knowledge information that the description information matches, and the second template source code. The above prompt information may be implemented based on the prompt information assembly template. The description information, the knowledge information matching the description information and one or more items of the second template source code are added to the corresponding positions of the prompts in the prompt information assembly template to obtain the prompt information.

Optionally, before the prompt information is input into the code generation model, the length of the prompt information is also checked. If the length of the prompt information is greater than a threshold, the amount of knowledge information matching the description information is reduced until the length of the prompt information is less than the threshold. Specifically, it may be by reducing the number K of knowledge information that the description information matches, or by increasing a predetermined threshold corresponding to the similarity data.

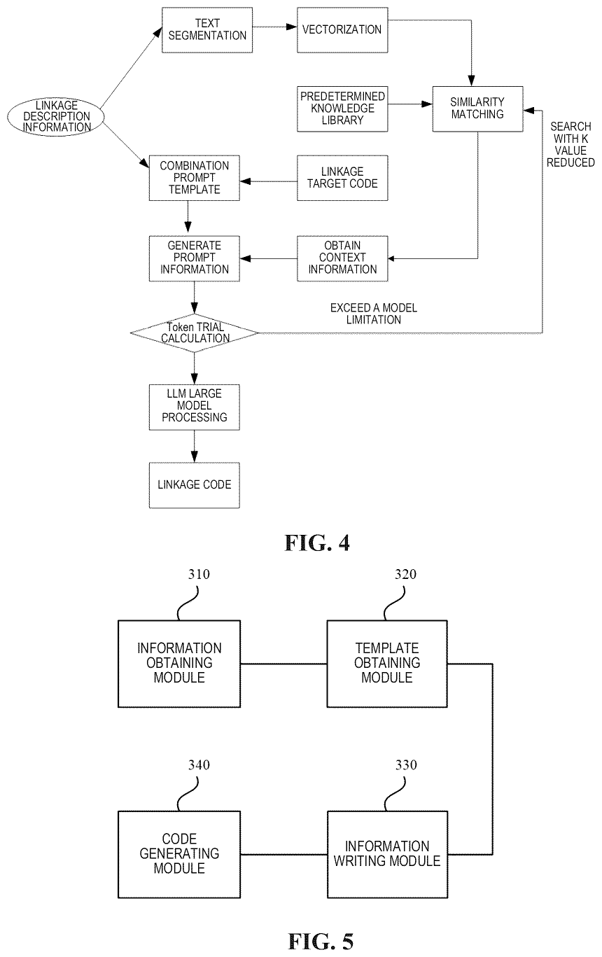

Based on the foregoing embodiment, referring to FIG. 4. FIG. 4 is a schematic diagram of a process of generating linkage code information according to the embodiments of the present disclosure. The linkage description information is obtained, and the linkage description information is processed by text segmentation and vectorization to obtain the vector information corresponding to the linkage description information. The vector information is matched in the predetermined knowledge library to determine the matching context information, which is the knowledge information matched with the description information. The linkage template source code corresponding to the linkage description information (i.e., the second template source code) is obtained, and the context information, linkage description information and linkage template source code are assembled to obtain the prompt information. A token trial calculation is performed on the prompt information to determine whether the length of the prompt information is greater than a threshold. If the length of the prompt information is greater than the threshold, the amount of information k in the context information is reduced. If the length of the prompt information is less than the threshold, the prompt word is input into a LLM model to obtain the linkage code information output by the LLM model, i.e., the second code information.

It may be appreciated that FIG. 4 is merely an example. When the linkage description information is replaced with the verification description information, the verification code information corresponding to the verification description information is generated based on the schematic diagram shown in FIG. 4.

On the basis of the above embodiment, the first code information, the second code information and the target code information are all generated in the code editing application. The target form page is displayed in the network view, and the data communication between the code editing application and the network view is pre-established. For example, the communication interface between the code editing application and the network view is established to implement the data transmission between the code editing application and the network view, so that the code information generated in the code editing application may be rendered in the network view, implementing the visual development of the target form page. As an example, a code editing application could be a VSCode application, where a React environment may be built in the VSCode application. The React environment includes both local development and production. A view folder is created in the VSCode application to maintain the React application code, and package the React code separately. Two sets of packaging configuration are maintained for the production environment and the local development environment. Different paths for React application resources are set depending on the environment, and the path is injected into the script src of the webview html to load the React application.

Optionally, the code information corresponding to the target form page generated in the code editing application is converted into a static resource, the static resource is injected into a page file of a network view, and the target form page in the network view is rendered based on the static resource in the page file, wherein the code editing application pre-establishes data communication with the network view. The page file may be a page file of the network view, for example, an HTML file. The network view may render the content in the HTML file, implementing display of the target form page.

In this embodiment, the code information corresponding to the target form page generated by the code editor application is packaged and converted into a static resource. Through the communication interface between the code editor application and the network view, the static resource is injected into the page file of the network view, and the content of the page file is rendered in the network view. the target form page is rendered without closing the webview page.

Optionally, the code information corresponding to the target form page is periodically converted into a static resource and injected into the page file. Through a regular update of the page file, the regular hot update of the view corresponding to the target form page is implemented. In the process of each hot update, the object code information corresponding to the target form page may be converted into a static resource, injected into the page file, and the content of the page file is updated. It may also obtain the incremental code information corresponding to the target form page, convert the incremental code information into a static resource, inject into the page file, and update the content of the page file. The network view renders the content of the updated page file to implement regular hot updates to the target form page.

FIG. 5 is a schematic structural diagram of an apparatus for generating form page code provides in the embodiments of the present disclosure. As shown in FIG. 2, the apparatus includes: an information obtaining module 310, a template obtaining module 320, an information writing module 330, and a code generating module 340.

The information obtaining module 310 is configured to obtain a pre-configuration file corresponding to a target form page, and parsing the pre-configuration file to obtain field information in the target form page.

The template obtaining module 320 is configured to obtain predetermined first template source code, the first template source code including a non-editable portion and an editable portion, and the editable portion including an operator and a field to be defined and corresponding to the operator.

The information writing module 330 is configured to write the field information of the pre-configuration file into the field to be defined of the first template source code.

The code generating module 340 is configured to generate editing code information based on the operator and the field information of the pre-configuration file, code information of the non-editable portion and the editing code information generating first code information corresponding to the target form page.

According to the technical solution provided by the embodiment, a template source code is set, code information of a target form page is generated through the template source code, and the code information of the form page generated through the template source code has the same development style, to maintain the code information of different form pages conveniently. Meanwhile, the template source code includes a non-editable portion and an editable portion, the editable portion may be updated through the pre-configuration file corresponding to the target form page, without editing the non-editable portion, improving the standardization of the code information of the target form page, and avoiding bugs caused by manual writing, reducing the bug rate. Furthermore, operator is set in the editable portion of the template source code, and by performing corresponding operation on the field information by the operator in the pre-configuration file, the editing code information is obtained, thereby implementing automatic generation of the structured information.

Based on the foregoing embodiment, optionally, the code generating module 340 is configured to: recognize the operator, and performing an operation corresponding to the operator on field information corresponding to the operator.

Optionally, t the operator includes one or more of a loop traversal operator, a replacement operator, an insertion operator, and an import operator; and wherein the loop traversal operator is configured to traverse each of fields of the pre-configuration file to generate component code information corresponding to each of the fields; the replacement operator is configured to replace source code information of the first template source code with new code information; the insertion operator is configured to insert new code information into the first template source code; and the import operator is configured to import defined field information of the pre-configuration file.

On the basis of the foregoing embodiment, optionally, the pre-configuration file further includes description information.

The code generating module 340 is further configured to generate prompt information based on the description information, and generating second code information based on the prompt information by using a code generation model, and generate target code information corresponding to the target form page based on the first code information and the second code information.

Optionally, the description information includes verification description information and/or field linkage description information, and the second code information includes verification code information and/or linkage code information.

Optionally, the code generating module 340 is further configured to obtain second template source code corresponding to the description information, and generating the prompt information based on the second template source code and the description information; generate the second code information based on the prompt information by using the code generation model.

Optionally, the code generating module 340 is further configured to convert the description information into vector information; perform, for the vector information, similarity matching in a predetermined knowledge library to obtain knowledge information matching the description information, the predetermined knowledge library including vector information corresponding to a predetermined knowledge document; update the prompt information based on the knowledge information matching the description information; and generate the second code information based on the prompt information by using the code generation model.

Based on the foregoing embodiment, optionally, the information obtaining module 310 is further configured to: display the field information of the target form page on an interaction page; and in response to an editing operation on the field information on the interaction page, update the field information.

Based on the foregoing embodiment, optionally, code information corresponding to the target form page is generated in a code editing application, and wherein the code information corresponding to the target form page includes one or more of the first code information and the target code information.

The apparatus further includes: a form page rendering module configured to convert the code information corresponding to the target form page generated in the code editing application into a static resource, injecting the static resource into a page file of a network view, and rendering the target form page in the network view based on the static resource in the page file, wherein the code editing application pre-establishes data communication with the network view.

The apparatus for generating form page code provided by the embodiments of the present disclosure may perform the method of generating form page code provided by any embodiment of the present disclosure and has the corresponding functional modules and beneficial effects of the execution method.

It would be noted that the units and modules included in the foregoing apparatus are only divided based on logic of the function, but are not limited to the foregoing division, as long as the corresponding functions may be implemented. In addition, the specific names of the functional units are merely for ease of distinguishing, and are not intended to limit the protection scope of the embodiments of the present disclosure.

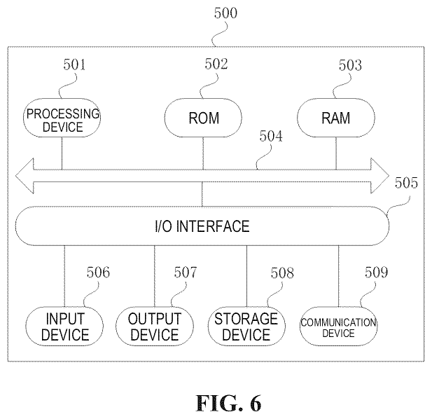

FIG. 6 is a schematic structural diagram of an electronic device according to an embodiment of the present disclosure. FIG. 6 is a schematic structural diagram of an electronic device 500 (such as the terminal device or server in FIG. 6) suitable for implementing the embodiments of the present disclosure. The terminal device in embodiments of the present disclosure may include, but are not limited to, a mobile terminal such as a mobile phone, a notebook computer, a digital broadcast receiver, a PDA (personal digital assistant), a PAD (tablet computer), a PMP (portable multimedia player), an in-vehicle terminal (for example, an in-vehicle navigation terminal), and a fixed terminal such as a digital TV, a desktop computer, or the like. The electronic device shown in FIG. 6 is only an example and shall not impose any limitation on the functionality and scope of use of the embodiment of the present disclosure.

As shown in FIG. 6, the electronic device 500 may include a processing device (for example, a central processing unit, a graphics processor, etc.) 501, which may perform various appropriate actions and processing according to a program stored in a read-only memory (ROM) 502 or a program loaded into a random access memory (RAM) 503 from a storage device 508. In the RAM 503, various programs and data required by the operation of the electronic device 500 are also stored. The processing device 501, the ROM 502, and the RAM 503 are connected to each other through a bus 504. An edit/output (I/O) interface 505 is also connected to the bus 504.

Generally, the following devices may be connected to the I/O interface 505: an input device such as a touch screen, touch pad, keyboard, mouse, camera, microphone, accelerometer, gyroscope, etc. 506; an output device including, for example, a liquid crystal display (LCD), loudspeaker, vibrator, etc. 507; a storage device, such as magnetic tape, hard disk, etc. 508; and a communication device 509. The communication device 509 may allow the electronic device 500 to communicate wirelessly or wirelessly with other devices to exchange data. Although FIG. 6 shows the electronic device 500 with various devices, it would be appreciated that the implementation or availability of all the devices shown is not required. It is possible to implement or have more or fewer devices instead.

In particular, according to an embodiment of the present disclosure, the process described above with reference to the flowchart may be implemented as a computer software program. For example, an embodiment of the present disclosure includes a computer program product including a computer program carried on a non-transitory computer readable medium. The computer program include program code for performing a method shown in the flow chart. In such an embodiment, the computer program may be downloaded and installed from the network by means of the communication device 509, or from the storage device 508, or from the ROM 502. When the computer program is executed by the processing device 501, the above functions defined in the methods of the embodiments are performed.

The names of messages or information exchanged between the plurality of devices in embodiments of the present disclosure are for illustrative purposes only and are not intended to limit the scope of such messages or information.

The electronic device provided by the embodiments of the present disclosure and the method of generating form page code g provided in the foregoing embodiments belong to the same inventive concept. Technical details not exhaustively described in this embodiment may be found in the above embodiment, and this embodiment has the same beneficial effects as the above embodiment.

An embodiment of the present disclosure provides a computer storage medium having a computer program stored thereon, the program, when executed by a processor, implements the method for generating form page code provided in the foregoing embodiments.

It would be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, apparatus, or device, or any combination thereof. More specific examples of computer-readable storage media may include, but are not limited to: an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or appliance. In the present disclosure, a computer readable signal medium may include a data signal propagated in baseband or as part of a carrier, wherein the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or appliance. The program code embodied on the computer-readable medium may be transmitted with any suitable medium, including, but not limited to, wires, optical cables, RF (radio frequency), and the like, or any suitable combination of the foregoing.

In some implementations, the client, server may communicate using any currently known or future developed network protocol, such as HTTP (HyperText Transfer Protocol), and may be interconnected with any form or medium of digital data communication (e.g., a communication network). Examples of communication networks include local area network (‘LAN’), wide area network (‘WAN’) , internets (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer-readable medium carries one or more programs, and when the one or more programs are executed by the electronic device, the electronic device is caused to:

The computer readable medium carries one or more programs. When the one or more programs are executed by the electronic device, the electronic device is caused to: obtain a pre-configuration file corresponding to a target form page, and parsing the pre-configuration file to obtain field information in the target form page; obtain predetermined first template source code, the first template source code including a non-editable portion and an editable portion, and the editable portion including an operator and a field to be defined and corresponding to the operator;

Write the field information of the pre-configuration file into the field to be defined of the first template source code; generate editing code information based on the operator and the field information of the pre-configuration file, code information of the non-editable portion and the editing code information generating first code information corresponding to the target form page.

Computer program code for performing the operations of the present disclosure may be written in one or more programming languages, including, but not limited to, object oriented programming languages such as Java, Smalltalk, C ++, and conventional procedural programming languages, such as the ‘C’ language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate architecture, function, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It would also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the function involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. Therein, the name of a unit does not qualify the unit itself in some way, for example, the first obtaining unit may be further described as ‘obtaining at least two units of Internet Protocol addresses’.

The functions described above may be performed, at least in part, by one or more hardware logic components. For example, without limitation, example types of hardware logic components that may be used including: field programmable gate arrays (FPGAs), application specific integrated circuits (ASICs), application specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

The description above is merely an illustration of the preferred embodiments of the present disclosure and the principles of the application. It would be appreciated by those skilled in the art that the disclosure in the present disclosure is not limited to the technical solutions of the specific combination of the above technical features and would also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this would not be appreciated to require that these operations be performed in the particular order shown or in sequential order. In certain circumstances, multitasking and parallel processing may be advantageous. Likewise, while several specific implementation details are included in the discussion above, these would not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be appreciated that the subject matter defined in the appended claims is not necessarily limited to the specific features or acts described above. Rather, the specific features and acts described above are merely exemplary forms of implementing the claims.

I/We claim:

1. A method of generating form page code, comprising:
obtaining a pre-configuration file corresponding to a target form page, and parsing the pre-configuration file to obtain field information in the target form page;
obtaining predetermined first template source code, the first template source code comprising a non-editable portion and an editable portion, and the editable portion comprising an operator and a field to be defined and corresponding to the operator;
writing the field information of the pre-configuration file into the field to be defined of the first template source code; and
generating editing code information based on the operator and the field information of the pre-configuration file, code information of the non-editable portion and the editing code information generating first code information corresponding to the target form page.

2. The method of claim 1, wherein generating the editing code information based on the operator and the field information of the pre-configuration file comprises:
recognizing the operator, and performing an operation corresponding to the operator on field information corresponding to the operator.

3. The method of claim 1, wherein the operator comprises one or more of a loop traversal operator, a replacement operator, an insertion operator, and an import operator; and
wherein the loop traversal operator is configured to traverse each of fields of the pre-configuration file to generate component code information corresponding to each of the fields;
the replacement operator is configured to replace source code information of the first template source code with new code information;
the insertion operator is configured to insert new code information into the first template source code; and
the import operator is configured to import defined field information of the pre-configuration file.

4. The method of claim 1, wherein the pre-configuration file further comprises description information; and the method further comprises:
generating prompt information based on the description information, and generating second code information based on the prompt information by using a code generation model; and
generating target code information corresponding to the target form page based on the first code information and the second code information.

5. The method of claim 4, wherein the description information comprises verification description information and/or field linkage description information, and the second code information comprises verification code information and/or linkage code information.

6. The method of claim 4, further comprising:
obtaining second template source code corresponding to the description information, and generating the prompt information based on the second template source code and the description information; and
generating the second code information based on the prompt information by using the code generation model.

7. The method of claim 4, further comprising:
converting the description information into vector information;
performing, for the vector information, similarity matching in a predetermined knowledge library to obtain knowledge information matching the description information, the predetermined knowledge library comprising vector information corresponding to a predetermined knowledge document;
updating the prompt information based on the knowledge information matching the description information; and
generating the second code information based on the prompt information by using the code generation model.

8. The method of claim 1, further comprising:
displaying the field information of the target form page on an interaction page; and
in response to an editing operation on the field information on the interaction page, updating the field information.

9. The method of claim 4, wherein code information corresponding to the target form page is generated in a code editing application, and wherein the code information corresponding to the target form page comprises one or more of the first code information and the target code information; and
the method further comprises: converting the code information corresponding to the target form page generated in the code editing application into a static resource, injecting the static resource into a page file of a network view, and rendering the target form page in the network view based on the static resource in the page file, wherein the code editing application pre-establishes data communication with the network view.

10. An electronic device, comprising:
one or more processors; and
a storage apparatus, configured to store one or more programs, the one or more programs, when executed by the one or more processors, causing the one or more processors to perform acts comprising:
obtaining a pre-configuration file corresponding to a target form page, and parsing the pre-configuration file to obtain field information in the target form page;
obtaining predetermined first template source code, the first template source code comprising a non-editable portion and an editable portion, and the editable portion comprising an operator and a field to be defined and corresponding to the operator;
writing the field information of the pre-configuration file into the field to be defined of the first template source code; and
generating editing code information based on the operator and the field information of the pre-configuration file, code information of the non-editable portion and the editing code information generating first code information corresponding to the target form page.

11. The electronic device of claim 10, wherein generating the editing code information based on the operator and the field information of the pre-configuration file comprises:
recognizing the operator, and performing an operation corresponding to the operator on field information corresponding to the operator.

12. The electronic device of claim 10, wherein the operator comprises one or more of a loop traversal operator, a replacement operator, an insertion operator, and an import operator; and
wherein the loop traversal operator is configured to traverse each of fields of the pre-configuration file to generate component code information corresponding to each of the fields;
the replacement operator is configured to replace source code information of the first template source code with new code information;
the insertion operator is configured to insert new code information into the first template source code; and
the import operator is configured to import defined field information of the pre-configuration file.

13. The electronic device of claim 10, wherein the pre-configuration file further comprises description information, and the acts further comprise:
generating prompt information based on the description information, and generating second code information based on the prompt information by using a code generation model; and
generating target code information corresponding to the target form page based on the first code information and the second code information.

14. The electronic device of claim 13, wherein the description information comprises verification description information and/or field linkage description information, and the second code information comprises verification code information and/or linkage code information.

15. The electronic device of claim 13, wherein the acts further comprise:
obtaining second template source code corresponding to the description information, and generating the prompt information based on the second template source code and the description information; and
generating the second code information based on the prompt information by using the code generation model.

16. The electronic device of claim 13, wherein the acts further comprise:
converting the description information into vector information;
performing, for the vector information, similarity matching in a predetermined knowledge library to obtain knowledge information matching the description information, the predetermined knowledge library comprising vector information corresponding to a predetermined knowledge document;
updating the prompt information based on the knowledge information matching the description information; and
generating the second code information based on the prompt information by using the code generation model.

17. The electronic device of claim 10, wherein the acts further comprise:
displaying the field information of the target form page on an interaction page; and
in response to an editing operation on the field information on the interaction page, updating the field information.

18. The electronic device of claim 13, wherein code information corresponding to the target form page is generated in a code editing application, and wherein the code information corresponding to the target form page comprises one or more of the first code information and the target code information; and
the acts further comprise: converting the code information corresponding to the target form page generated in the code editing application into a static resource, injecting the static resource into a page file of a network view, and rendering the target form page in the network view based on the static resource in the page file, wherein the code editing application pre-establishes data communication with the network view.

19. A non-transitory storage medium comprising computer-executable instructions, wherein the computer-executable instructions, when executed by a computer processor, are configured to perform acts comprising:
obtaining a pre-configuration file corresponding to a target form page, and parsing the pre-configuration file to obtain field information in the target form page;
obtaining predetermined first template source code, the first template source code comprising a non-editable portion and an editable portion, and the editable portion comprising an operator and a field to be defined and corresponding to the operator;
writing the field information of the pre-configuration file into the field to be defined of the first template source code; and
generating editing code information based on the operator and the field information of the pre-configuration file, code information of the non-editable portion and the editing code information generating first code information corresponding to the target form page.

20. The non-transitory storage medium of claim 19, wherein generating the editing code information based on the operator and the field information of the pre-configuration file comprises:
recognizing the operator, and performing an operation corresponding to the operator on field information corresponding to the operator.
